(19) United States
(12) Patent Application Publication
(10) Pub. No.: US 2021/0279300 A1
(43) Pub. Date: Sep. 9, 2021

(54) Maintenance System

(71) Applicant: Liricco Technologies Ltd., Hong Kong (CN)

(72) Inventors: Mei NG, Toronto, Ontario (CA); Ka Chun LI, Hong Kong (CN)

(21) Appl. No.: 16/338,846

(22) PCT Filed: Oct. 2, 2016
(86) PCT No.: PCT/CN2016/101422

§ 371 Date: Apr. 2, 2019

(51) Int. Cl. G06F 17/40; H04L 29/08; G06Q 10/00

(52) U.S. Cl. CPC G06F 17/40; H04W 4/38; G06Q 10/20; H04L 67/12

(57) ABSTRACT

A maintenance system for maintaining a lighting system is provided. The maintenance system comprises at least one performance sensor for detecting a performance parameter of a lighting device in the lighting system. A data acquisition module receives performance data from the performance sensor, with the performance data corresponding to the performance parameter. A maintenance server receives the performance data from the data acquisition module. A user device is provided whereby the maintenance server sends an open maintenance request to the user device when the performance data reaches a predetermined deficiency threshold. The user device is adapted to receive a user input to indicate an acceptance of the open maintenance request and to send the acceptance to the maintenance server. The maintenance server then changes the open maintenance request to a closed maintenance request and sends the closed maintenance request to the user device.

### FIELD OF THE INVENTION

The invention relates to maintenance systems, and in particular, real time maintenance systems for maintaining lighting systems.

### BACKGROUND OF THE INVENTION

Commercial and large-scale lighting systems typically use a wired network and can be part of a broader building management system (BMS). As such, these lighting systems require dedicated wiring and control systems that are usually installed during the construction or fit-out phases of a building.

For existing buildings, re-wiring and the installation of new wiring is usually quite costly and time-consuming resulting in relatively long down-times. Total costs are often prohibitive. Typical retrofitting activities include replacing conventional lights with light emitting diode (LED) lights. Control systems and BMSs are not usually retrofitted unless a major renovation is undertaken.

One important aspect of lighting systems is maintenance management including fault detection, repair, and testing. Typically, this has been undertaken manually. Occupants or maintenance workers identify faulty lights and replace them themselves or lodge a request with the maintenance office of a building to replace the faulty lights. This means that faulty lights in low traffic areas or facilities such as carparks may not be promptly replaced. The tracking of faulty lights and whether they have been replaced is often inefficient and error prone. For example, if the locations of faulty lights are not properly recorded or easily identifiable, it can be difficult or time-consuming for maintenance workers to locate the faulty lights. If the replacement of a faulty light is not properly and promptly recorded, further maintenance workers may attempt to replace the already replaced light.

Some prior networked lighting systems, such as those connected to a BMS, are able to detect the power quality through the system, and thereby detect power anomalies in the system. This allows the system operator to identify faulty lights. However, the same problems discussed above in relation to the tracking of faulty lights and whether they have been replaced are also present in these systems.

Other prior maintenance systems make use of an installation history database to predict which lights in a system are approaching the end of their design lives. These lights are then replaced preemptively. However, similar to the problems discussed above, if the locations of lights coming to the end of their design lives are not properly recorded or easily identifiable, it can be difficult or time-consuming for maintenance workers to locate the lights. If the replacement of a light coming to the end of its design life is not properly and promptly recorded, further maintenance workers may attempt to replace the already replaced light. Furthermore, the prediction of the end of the design life of a light is necessarily an estimate, and there will inevitably be cases where a light is replaced earlier than necessary and cases where a light has failed much later than the prediction.

Another example involving testing is emergency lighting. Periodic testing is typically carried out manually by maintenance workers. In particular, a maintenance worker is required to physically locate an emergency light and then press the test button on the emergency light. This is still the case in respect of prior networked lighting systems.

It is an object of the present invention to overcome or ameliorate at least one of the disadvantages of the prior art, or to provide a useful alternative.

### SUMMARY OF THE INVENTION

The present invention provides, in one aspect, a maintenance system for maintaining a lighting system, the maintenance system comprising:

at least one performance sensor for detecting a performance parameter of a lighting device in the lighting system;

a data acquisition module for receiving performance data from the performance sensor, the performance data corresponding to the performance parameter;

a maintenance server for receiving the performance data from the data acquisition module; and

a user device, the maintenance server sending an open maintenance request to the user device when the performance data reaches a predetermined deficiency threshold, the user device adapted to receive a user input to indicate an acceptance of the open maintenance request and to send the acceptance to the maintenance server, the maintenance server then changing the open maintenance request to a closed maintenance request and sending the closed maintenance request to the user device.

In another aspect, the present invention provides a maintenance system for maintaining a lighting system, the maintenance system comprising:

at least one performance sensor for detecting a performance parameter of an emergency lighting device in the lighting system, the emergency lighting device powered by a battery when mains power to the emergency lighting device or the lighting system is cut;

a data acquisition module for receiving performance data from the performance sensor, the performance data corresponding to the performance parameter; and

a maintenance server for receiving the performance data from the data acquisition module, and initiating at a predetermined time an automatic test of the emergency lighting device by cutting mains power supplied to the emergency lighting device or the lighting system, the at least one performance sensor detecting the performance parameter of the emergency lighting device during the automatic test.

In a further aspect, the present invention provides a method of maintaining a lighting system, the method comprising:

detecting at least one performance parameter of a lighting device in the lighting system;

sending performance data corresponding to the performance parameter to a maintenance server;

sending an open maintenance request to a user device when the performance data reaches a predetermined deficiency threshold;

receiving a user input at the user device to indicate an acceptance of the open maintenance request and to send the acceptance to the maintenance server;

changing the open maintenance request to a closed maintenance request at the maintenance server; and

sending the closed maintenance request to the user device.

Other features and embodiments of the present invention can be found in the appended claims.

Throughout this specification, including the claims, the words “comprise”, “comprising”, and other like terms are to be construed in an inclusive sense, that is, in the sense of “including, but not limited to”, and not in an exclusive or exhaustive sense, unless explicitly stated otherwise or the context clearly requires otherwise.

### BRIEF DESCRIPTION OF THE FIGURES

Preferred embodiments in accordance with the best mode of the present invention will now be described, by way of example only, with reference to the accompanying figures, in which the same reference numerals refer to like parts throughout the figures unless otherwise specified, and in which:

FIG. 1 is a schematic diagram of a maintenance system in accordance with a preferred embodiment of the invention;

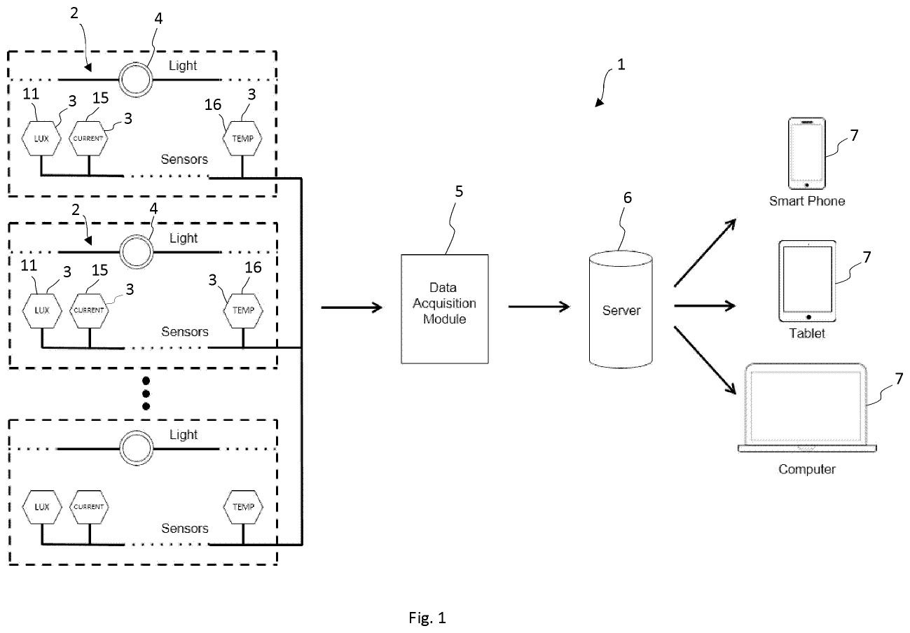

FIG. 2 is a schematic diagram of a maintenance system in accordance with a preferred embodiment of the invention showing some user interface screens;

FIG. 3 is a schematic diagram of a maintenance system in accordance with another preferred embodiment of the invention;

FIG. 4 is a flowchart showing the operation of a maintenance system in accordance with a preferred embodiment of the invention;

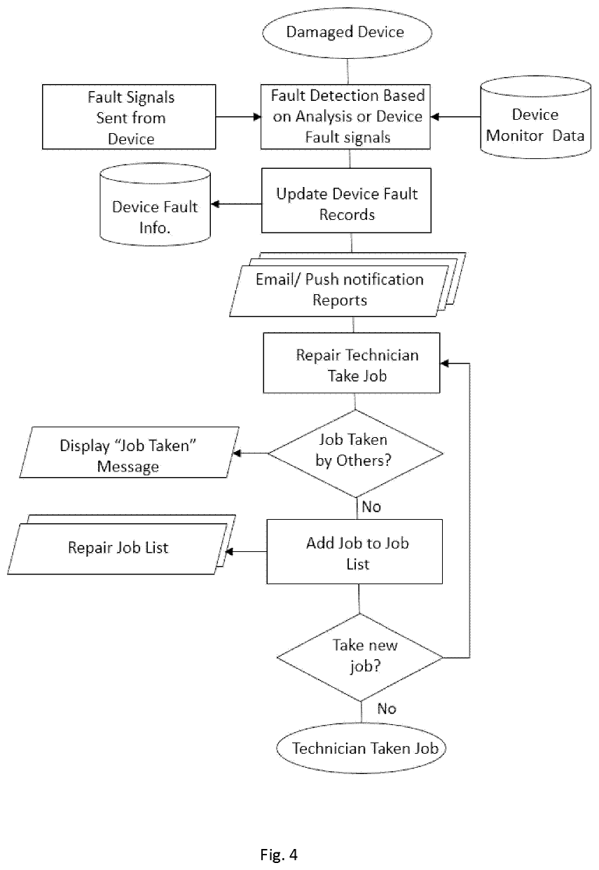

FIG. 5 is a flowchart showing the operation of a maintenance system in accordance with another preferred embodiment of the invention;

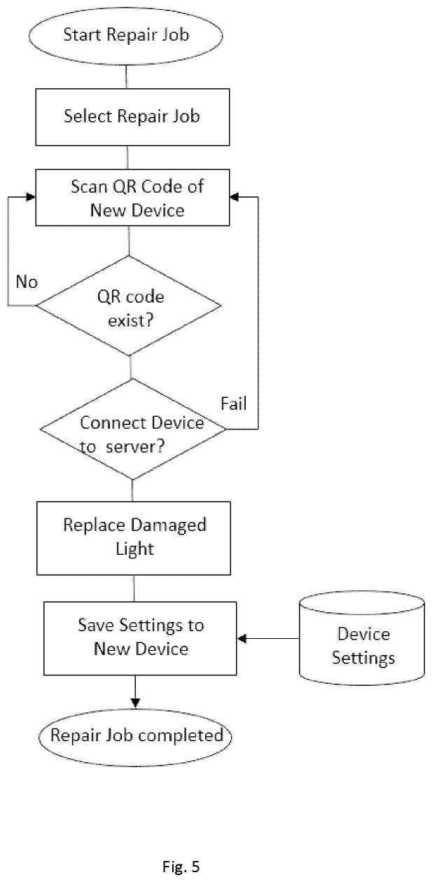

FIG. 6 is a flowchart showing the operation of a maintenance system in accordance with a further preferred embodiment of the invention;

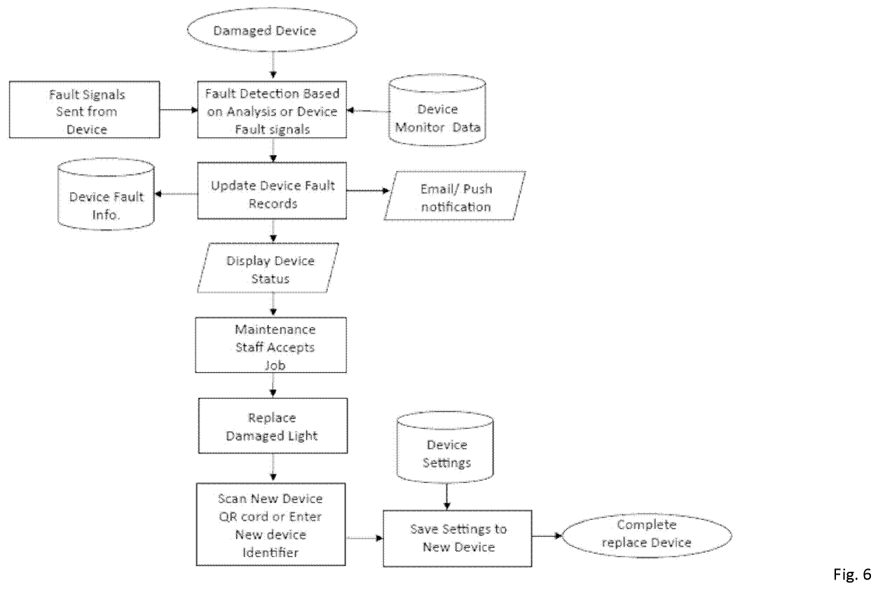

FIG. 7 is a schematic diagram of a maintenance system in accordance with a preferred embodiment of the invention shown in use with an emergency lighting device; and

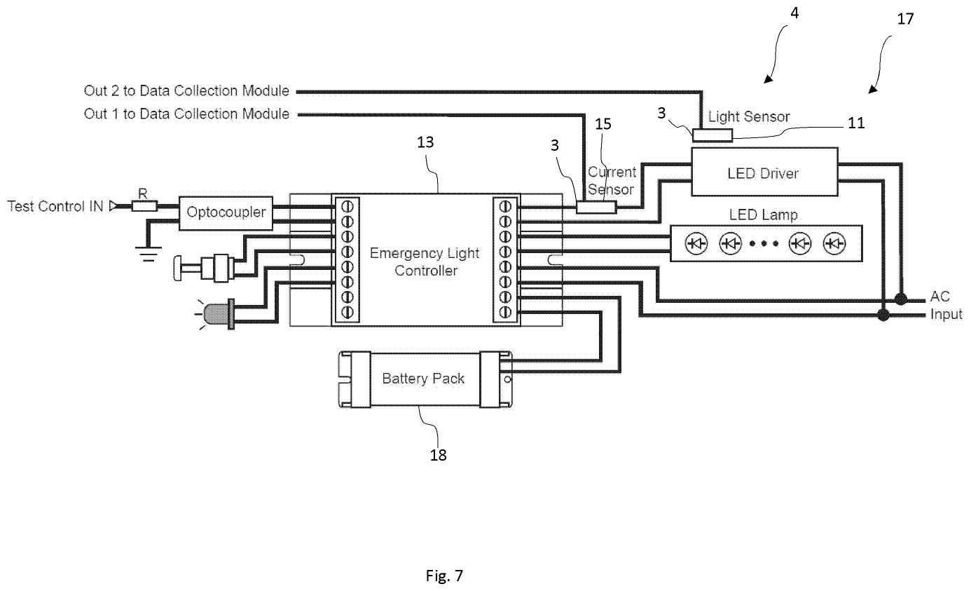

FIG. 8 is a graph showing the spectral output of a lighting device compared with the light wavelengths detected by a light detector of a maintenance system in accordance with a preferred embodiment of the invention.

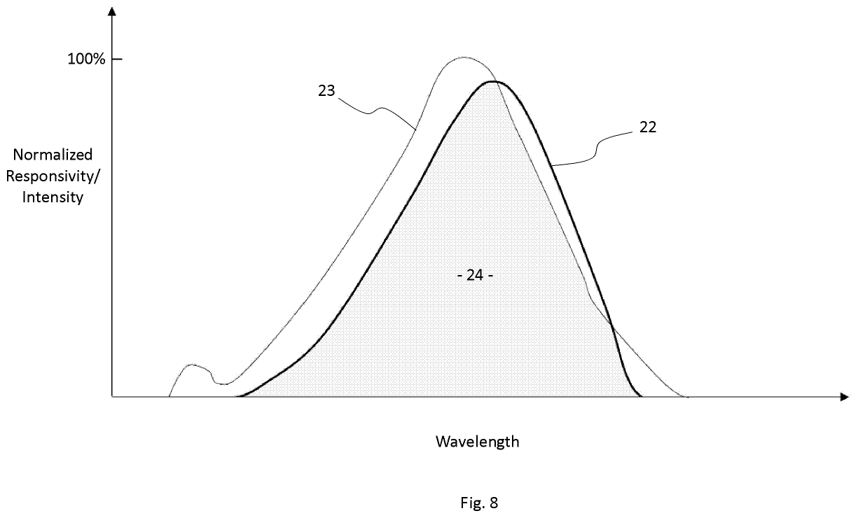

### DETAILED DESCRIPTION OF PREFERRED EMBODIMENTS OF THE INVENTION

Referring to the figures, there is provided a maintenance system 1 for maintaining a lighting system 2. The maintenance system 1 comprises at least one performance sensor 3 for detecting a performance parameter of a lighting device 4 in the lighting system 2. A data acquisition module 5 receives performance data from the performance sensor 3, with the performance data corresponding to the performance parameter. A maintenance server 6 receives the performance data from the data acquisition module 5. A user device 7 is provided whereby the maintenance server 6 sends an open maintenance request 8 to the user device when the performance data reaches a predetermined deficiency threshold. The user device 7 is adapted to receive a user input to indicate an acceptance of the open maintenance request 8 and to send the acceptance to the maintenance server 6. The maintenance server 6 then changes the open maintenance request 8 to a closed maintenance request 9 and sends the closed maintenance request to the user device 7.

Usually, and advantageously, the maintenance system comprises a plurality of the user devices 7. The maintenance server 6 sends the open maintenance request 8 to all the user devices 7 when the performance data reaches the predetermined deficiency threshold. The maintenance server 6 changes the open maintenance request 8 to the closed maintenance request 9 and sends the closed maintenance request to all the user devices 7 when one of the user devices 7 receives the user input to indicate the acceptance of the open maintenance request 8 and sends the acceptance to the maintenance server 6.

This means that a plurality of maintenance workers, contractors, or other personnel, can each have a user device 7. When a maintenance activity is required, which is automatically indicated by the performance data reaching the predetermined deficiency threshold, maintenance server 6 sends the open maintenance request 8 to all the user devices 7, thereby notifying all the maintenance personnel having a user device 7. When one of these maintenance personnel provides a user input on the user device 7 to indicate the acceptance of the open maintenance request 8, the user device 7 sends the acceptance to the maintenance server 6. The maintenance server 6 then changes the open maintenance request 8 to a closed maintenance request 9 and sends the closed maintenance request to all the user devices 7 notifying all maintenance personnel with a user device 7 that one of the maintenance personnel has already accepted the open maintenance request 8 and will perform the required maintenance activity. Thus, this avoids or ameliorates the problem of recording the performance of the required maintenance activity (e.g. replacement of a faulty light) properly and promptly so that further maintenance personnel do not attempt to also perform the same required maintenance activity.

The user input can be in the form of selecting the open maintenance request 8 which is listed on a screen of the user devices 7. The open maintenance request 8 can be one amongst a list of open maintenance requests 8. Once one user provides the user input, the maintenance server sends the closed maintenance request 9 to all the user devices 7. The closed maintenance request 9 can be in the form of simply removing the open maintenance request 8 from all the user devices 7, or it can be an actual entry listed on a screen of the user devices 7, or it can be in the form of changing the open maintenance request 8 listed on a screen of the user device 7 to the closed maintenance request 9.

In a further enhancement, the user device 7 is adapted to receive a user input to indicate a completed maintenance request 10 and to send the completed maintenance request to the maintenance server 6. Thus, there is positive confirmation that the maintenance activity covered by the open maintenance request 8 has been completed. Following on from above, for example, once the open maintenance request 8 is selected and the closed maintenance request 9 is listed on a screen of the user device 7, the user can provide the user input in the form of selecting the closed maintenance request 9 to indicate that the maintenance activity covered by the open, but now closed, maintenance request 8 and 9 is now complete. This selection indicates a completed maintenance request 10 and sends the completed maintenance request to the maintenance server 6. The user input can also include the user using a camera 19 on the user device 7 to read a visual code displayed on the lighting device 4. The visual code can be in the form of a bar code, QR code, or the like. Once the visual code is successfully read, a completed maintenance request 10 is indicated and sent to the maintenance server 6.

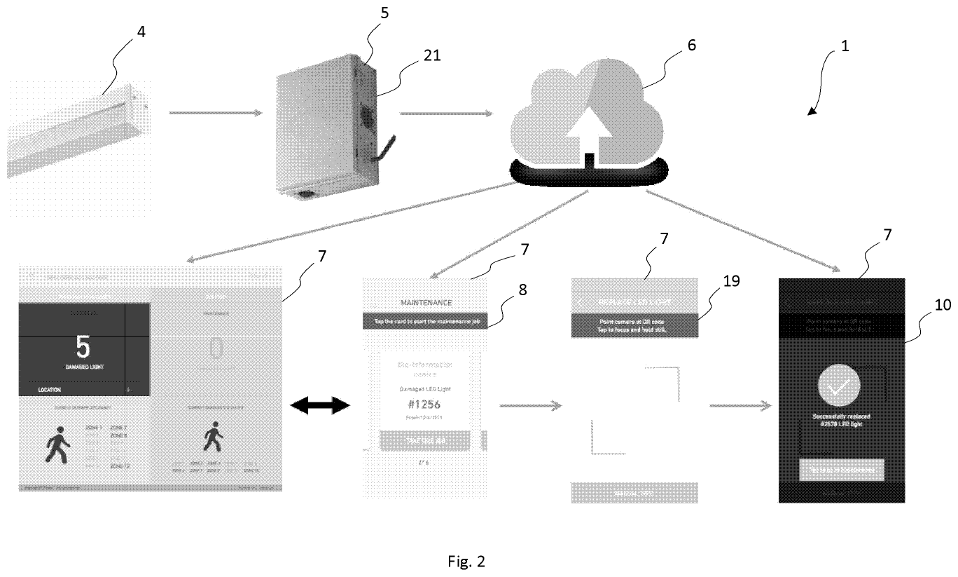

FIG. 2 shows several screens on user devices 7. One user device 7 is in the form of a smartphone 25. Another user device 7 is in the form of a desktop computer 26. The desktop computer can for example be located in a facilities management office which monitors the maintenance system. In this case, a screen on the desktop computer can include lists of open maintenance requests 8, closed maintenance requests 9, and closed maintenance requests 10. The screen can also display statistics gathered by the maintenance system 1 and a variety of other information gathered by the maintenance system 1 that is of interest to personnel in the facilities management office.

In one example, the open maintenance request 8 comprises a request to replace the lighting device 4. The lighting device 4 is replaced by another lighting device being a smart lighting device having configurable characteristics. The maintenance server 6 sends configuration data to said another lighting device (i.e. the smart lighting device) to configure the characteristics of said another lighting device after receiving the completed maintenance request 10.

If the lighting device 4 being replaced is also a said smart lighting device, the configuration data sent to said another lighting device is the configuration data for the lighting device 4 being replaced.

A smart lighting device, for example, comprises an activity sensor for detecting activity in a proximity of the smart lighting device, and the configurable characteristics is one or more of: a dimmed light level; an active light level; and a hold time corresponding to the time period over which the smart lighting device outputs a light level at the active light level before outputting a light level at the dimmed light level provided that the activity detected by the activity sensor remains below an activity threshold during the hold time. As an example of a practical application, such a smart lighting device can be installed in a carpark, or other low traffic area. The activity sensor is a movement sensor for detecting the activity of movement in a proximity of the smart lighting device. The activity threshold is set at a level that small movements, such as those of objects caused by wind, are below the activity threshold, and larger movements such as those of people passing by the smart lighting device, are above the activity threshold. The aim of this is to minimise false positives. When there is no activity at or above the activity threshold, the smart lighting device outputs a light level at the dimmed light level. When activity at or above the activity threshold is detected, the smart lighting device outputs a light level at the active light level. Once the activity detected falls below the activity threshold, the light output is held at the active light level for the duration of the hold time provided that the activity detected by the activity sensor remains below the activity threshold during the hold time. If at any time during the hold time, the activity detected reaches the activity threshold again, the smart lighting device once again waits until the activity detected falls below the activity threshold, and once again holds the light output at the active light level for the duration of the hold time, again, provided that the activity detected by the activity sensor remains below the activity threshold during the hold time.

The user device 7 can be a dedicated or custom-built device for the maintenance system 1. In the present preferred embodiment, the user device 7 is a general computing device having a software application to enable the general computing device to operate as the user device 7 for the maintenance system 1. For example, the general computing device is a smartphone, tablet, or other personal mobile device, and the software application is an app downloadable onto the personal mobile device. Advantageously, maintenance personnel can simply download an app onto their own smartphone and thereby use their smartphone as the user device 7.

The lighting system 2 comprises a plurality of the lighting devices 4. The maintenance system 1 comprises at least one performance sensor 3 for each lighting device 4. In some embodiments, there are multiple performance sensors 3 for each lighting device 4. Each performance sensor 3 is for detecting a performance parameter of the respective lighting device 4. There can also be one or more of the data acquisition modules 5. The data acquisition modules 5 are for receiving sets of performance data, with each set from a respective performance sensor 3 and corresponding to the performance parameter of the respective lighting device 4. The maintenance server 6 receives the performance data from the one or more data acquisition modules 5.

In one embodiment, there is only one data acquisition module 5 that receives all the performance data from all the performance sensors 3, and sends the performance data to the maintenance server 6.

In another embodiment, there is a plurality of data acquisition modules 5, each receiving performance data from a respective sub-group of the performance sensors 3. The sub-groups can be exclusive in that each performance sensor 3 only ever belongs to one sub-group. Alternatively, one or more of the performance sensors 3 can belong to multiple sub-groups, so that the performance data from these one or more performance sensors 3 can be received by multiple data acquisition modules 5. This builds in redundancy to the system in case a data acquisition module breaks down or is otherwise unavailable. A performance sensor 3 can permanently belong to multiple sub-groups or can switch or selectively allocated to different sub-groups.

In another embodiment, there is a plurality of data acquisition modules 5, each receiving performance data from only one respective performance sensor 3. Thus, there is a one-to-one correspondence between the data acquisition modules 5 and the performance sensors 3. A performance sensor 3 can be permanently allocated to a data acquisition module 5 or can be switched or selectively allocated to a different data acquisition module 5, whilst maintaining or without maintaining a one-to-one correspondence.

The lighting device 4 comprises one or more light emitting diodes (LEDs). However, the lighting device 4 can comprise other types of light sources, such as incandescent, fluorescent, halogen, metal halide, and high intensity discharge (HID).

Examples of specific types of performance sensors 3 will now be described.

In one embodiment, at least one performance sensor 3 comprises a light detector 11 and the performance parameter is a light level outputted by the lighting device 4. The light detector 11 is positioned in close proximity to the lighting device 4 to minimise detection of ambient light and maximize detection of light provided by the lighting device 4.

In one particular example, the lighting device 4 comprises a plurality of light emitting diodes, and the light detector 11 comprises a plurality of light detector units each for measuring a light level outputted by one or more of the light emitting diodes. The light detector 11 measures an average light level outputted by the lighting device 4 based on the light levels measured by the plurality of light detector units.

The light detector 11 can also be of the type that filters out light frequencies that are not the main light frequencies emitted by the lighting device 4 to minimise detection of ambient light and maximize detection of light provided by the lighting device. Referring to FIG. 9, the light detector 11 can be selected or designed such that the normalized spectral responsivity 22 of the light detector 11 substantially overlaps the normalized spectral intensity 23 of the lighting device. The overlap represents that effective coupled energy 24 of the light detector 11.

Some lighting devices 4 have built-in redundancy in that they can tolerate power levels higher than the recommended power levels. With these lighting devices 4, a power supplied to the lighting device 4 is automatically increased to restore the light level outputted by the lighting device to a desired level when the light level reaches a predetermined deterioration threshold. For example, LEDs often deteriorate over time such that the light output decreases without the LED failing completely. In this case, the decreased light output is detected by the light detector 11 which sends performance data in this respect to the data acquisition module 5.

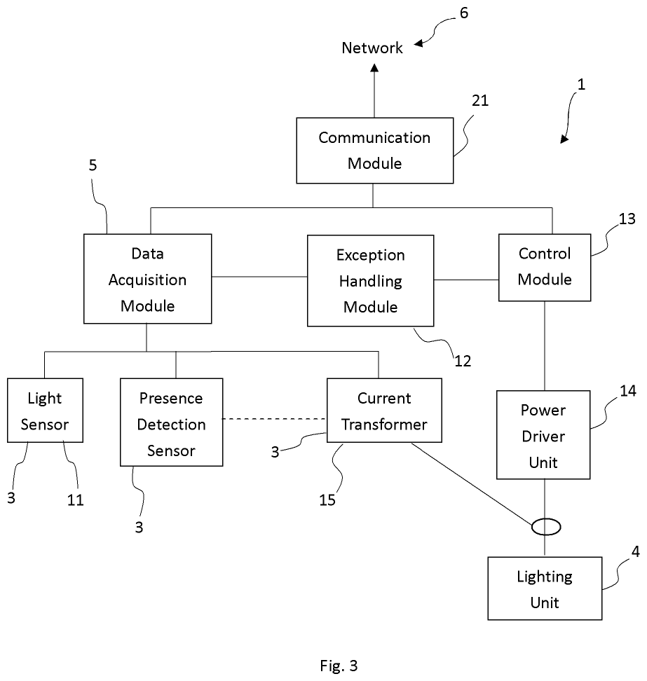

In one embodiment, the data acquisition module 5 is adapted to automatically increase the power supplied to the lighting device 4 to restore the light level outputted by the lighting device to a desired level when the light level reaches a predetermined deterioration threshold, that is, a decreased light level at which it is considered necessary to increase back up to the desired level. In one example, as shown in FIG. 3, there is included an exception handling module 12 which is connected to the data acquisition module 5. The exception handling module 12 can be connected to a control module 13 which in turn can be connected to a power driver unit 14 which can increase the power supplied to the lighting device 4. The exception handling module 12 receives performance data in the form of light output from the data acquisition module 5, and when the light output reaches the predetermined deterioration threshold, the exception handling module 12 signals the control module 13 to increase the power supplied to the lighting device 4 through the power driver unit 14. One or more of the data acquisition module 5, the exception handling module 12, the control module 13, and the power driver unit 14 can be integrated with the lighting device 4, or connected locally to the lighting device 4, or connected remotely to the lighting device 4.

In another embodiment, the data acquisition module 5 sends the performance data to the maintenance server 6. Instead of the data acquisition module 5, it is the maintenance server 6 that then automatically increases the power supplied to the lighting device 4 to restore the light level outputted by the lighting device to a desired level when the light level reaches a predetermined deterioration threshold. This can be done by the maintenance server 6 through the control module 13 and the power driver unit 14 similar to the manner described above. In this embodiment, the maintenance server 6 can also store the performance data (e.g. the light output level) for analysis or future reference.

In another embodiment, at least one performance sensor 3 comprises a current detector 15 and the performance parameter is a current flowing through the lighting device 4. The current detector 15 can be a current clamp, a current transformer, a Hall effect device, or any other detector device that detects an electrical parameter of the lighting device 4 from which the current flowing through the lighting device can be derived. The current detector 15 is preferably of a type that can be easily installed or retrofitted to the lighting device 4.

In another embodiment, at least one performance sensor 3 comprises a temperature detector 16 and the performance parameter is a temperature of the lighting device 4. In one particular example, the lighting device 4 comprises a printed circuit board (PCB) and the temperature detector 16 is configured to detect the temperature of the PCB. In embodiments where the lighting device 4 comprises a light emitting diode (LED), a junction temperature can be calculated based on the detected temperature. In one example, the temperature sensor 16 detects the temperature of a solder point of the light emitting diode. The junction temperature can be calculated from the following equation:

Tj=Ts+R*P, where Tj is the junction temperature, Ts is the solder point temperature, R is the thermal resistance of the LED, and P is the power inputted to the LED.

A power supplied to the lighting device 4 can be automatically decreased to reduce the temperature of the lighting device when the temperature reaches a maximum operating temperature. This safeguards the lighting device 4 from failure due to high temperatures. More specifically, the temperature is detected by the temperature detector 16 which sends performance data in this respect to the data acquisition module 5.

In one embodiment, the data acquisition module 5 is adapted to automatically decrease the power supplied to the lighting device 4 to reduce the temperature of the lighting device when the temperature reaches a maximum operating temperature. In one example, as shown in FIG. 3, there is included an exception handling module 12 which is connected to the data acquisition module 5. The exception handling module 12 can be connected to a control module 13 which in turn can be connected to a power driver unit 14 which can decrease the power supplied to the lighting device 4. The exception handling module 12 receives performance data in the form of temperature from the data acquisition module 5, and when the temperature reaches the maximum operating temperature, the exception handling module 12 signals the control module 13 to decrease the power supplied to the lighting device 4 through the power driver unit 14. One or more of the data acquisition module 5, the exception handling module 12, the control module 13, and the power driver unit 14 can be integrated with the lighting device 4, or connected locally to the lighting device 4, or connected remotely to the lighting device 4.

In another embodiment, the data acquisition module 5 sends the performance data to the maintenance server 6. Instead of the data acquisition module 5, it is the maintenance server 6 that then automatically decreases the power supplied to the lighting device 4 to reduce the temperature of the lighting device when the temperature reaches a maximum operating temperature. This can be done by the maintenance server 6 through the control module 13 and the power driver unit 14 similar to the manner described above. In this embodiment, the maintenance server 6 can also store the performance data (e.g. the temperature levels) for analysis or future reference.

The maintenance system 1 can have one or more performance sensors 3 of one or more different types, including but not limited to, the light detector 11, current detector 15, and temperature detector 16 described above.

In one embodiment, the lighting device 4 is an emergency lighting device 17 powered by a battery 18 when mains power to the emergency lighting device 17 or the lighting system 2 is cut. The maintenance server 6 initiates, at a predetermined time, an automatic test of the emergency lighting device 17 by cutting mains power supplied to the emergency lighting device 17 or the lighting system 2. The performance sensor 3 detects a performance parameter of the emergency lighting device 17 during the automatic test.

The emergency lighting device 17 can be a lighting device that operates normally to provide light based on mains power, but the provides light based on power stored in the battery 18 when mains power to the emergency lighting device 17 is cut or when mains power to the whole or a portion of the lighting system 2 is cut. The emergency lighting device 17 can also be a dedicated emergency lighting device which only provides light when mains power to the whole or a portion of the lighting system 2 is cut. The emergency lighting device 17 can be in the form of an illuminated sign such as an exit sign or a directional sign.

There can be a battery 18 for each emergency lighting device 17. That is, each emergency lighting device 17 is powered by its own battery 18 when the mains power to the emergency lighting device 17 or the lighting system 2 is cut. In another embodiment, only one central battery 18 is provided that powers all of the emergency lighting devices 17 in the lighting system 2 when mains power to the lighting system 2 is cut.

Having an automatic test is advantageous since emergency lighting devices are typically tested manually. A maintenance worker manually presses a test button 20 on the emergency lighting device 17 which cuts the mains power supplied to the emergency lighting device 17 or the whole or a portion of the lighting system 2. The maintenance worker then observes whether the emergency lighting device 17 is being powered by the battery and is on in order to conclude the test and confirm that the emergency lighting device 17 is operating properly. This is time-consuming and prone to errors especially if there are numerous emergency lighting devices or the tests are not preformed frequently enough or recorded properly. Importantly, this type of test also does not test the capacity of the battery 18 and whether this capacity has deteriorated over time.

In one version, the automatic test simply detects whether the emergency lighting device 17 turns on. In another version, the automatic test also detects whether a required light level is outputted by the emergency lighting device 17.

In another version, the automatic test has a duration equal to or greater than a required operating period. It is desirable, and in some countries there are standards that dictate, that emergency lighting devices operate for a minimum operating period at a required light level. Therefore, in one example, the maintenance server 6 cuts the mains power to operate the emergency lighting device 17 at the required light level over a required operating period that is equal to the minimum operating period. If it is desirable to perform the test quicker, that is, over a shorter required operating period, then the maintenance server 6 can control the emergency lighting device 17 so that the light level outputted by the emergency lighting device during the automatic test is higher. In this scenario, the required operating period is calculated such that the energy expended from the battery 18 over the required operating period at the higher light output level is equivalent to the energy expended from the battery 18 over the minimum operating period at the required light level.

In another version, the automatic test runs until the battery is flat or no longer provides sufficient power to enable the emergency lighting device to emit a minimum light level. This allows the battery 18 to be completely drained at regular intervals to maintain battery performance.

In some embodiments, the required light level of the emergency lighting device 17 when the mains power is cut (i.e. during emergency situations) is lower than the normal light level during normal operation. In these embodiments, it is sometimes desirable to operate the emergency lighting device 17 at the normal light level over the duration of the automatic test so that occupants do not see a change in light level from before the automatic test, during the automatic test, to after the automatic test. Accordingly, the maintenance server 6 can control the emergency lighting device 17 so that the light level outputted by the emergency lighting device during the automatic test is at the normal light level. If in this case, it is also desirable to have the automatic test run for a minimum operating period at the required light level, then the automatic test can be run over a required operating period that is calculated such that the energy expended from the battery 18 over the required operating period at the normal light output level is equivalent to the energy expended from the battery 18 over the minimum operating period at the required light level.

During the automatic test, the data acquisition module 5 receives the performance data (e.g. the existence of light output, the level of light output, the existence of current, the current level, the voltage output by the battery) and sends this to the maintenance server 6 which then sends an open maintenance request 8 if a maintenance activity is required, and records the results of the test.

More particularly, in these embodiments for automatically testing an emergency lighting device 17, the performance sensor 3 can be a current detector 11 and the performance parameter is a current flowing through the emergency lighting device 17 over a time period.

The maintenance server 6 sends an open maintenance request to the user device when the current falls below a minimum current within the required operating period. The current detector 11 can be placed at an output or an input of the emergency lighting device 17. The current detector 11 can also be placed at an output of the battery 18.

Alternatively or additionally, the performance sensor 3 can be a light detector 11 and the performance parameter is a light level outputted by the emergency lighting device over a time period. The maintenance server 6 sends an open maintenance request to the user device when the light level falls below a minimum light level within the required operating period.

Further types of performance sensors 3 can be used in the maintenance system 1. Also, there can be one or more performance sensors 3 of different types in the maintenance system 1.

These embodiments for automatically testing an emergency lighting device 17 can represent a standalone aspect of the present invention. In this aspect, broadly, the maintenance system 1 comprises at least one performance sensor 3 for detecting a performance parameter of an emergency lighting device 17 in the lighting system 2. The emergency lighting device 17 is powered by a battery 18 when mains power to the emergency lighting device 17 or the lighting system 2 is cut. A data acquisition module 5 receives performance data from the performance sensor 3, with the performance data corresponding to the performance parameter. A maintenance server 6 receives the performance data from the data acquisition module 5, and initiates at a predetermined time an automatic test of the emergency lighting device 17 by cutting mains power supplied to the emergency lighting device 17 or the lighting system 2. The performance sensor 3 detects the performance parameter of the emergency lighting device 17 during the automatic test.

In one embodiment, the automatic test has a duration equal to or greater than a required operating period. In another embodiment, the automatic test runs until the battery is flat or no longer provides sufficient power to enable the emergency lighting device to emit a minimum light level.

Advantageously, the present maintenance system 1 can be retrofitted. More particularly, the lighting system 2 is an existing lighting system, and one or more of the performance sensors 3 and the data acquisition module 5 are retrofitted to the lighting system. The maintenance server 6 can also be retrofitted to the lighting system 2.

The maintenance server 6 can be remote from the lighting system 2 and the maintenance system 1 comprises a communication module 21 to facilitate the sending or receiving of data between the data acquisition module 5 and the maintenance server 6.

The sending or receiving of data between the performance sensors 3 and the data acquisition module 5 is wireless, or between the data acquisition module 5 and the maintenance server 6 is wireless, or between the maintenance server 6 and the user devices 7 is wireless. This advantageously assists in facilitating retrofitting of the maintenance system 1 or some of its components to an existing lighting system since the requirement for wired connections can be minimized. Any suitable wireless protocol or protocols can be used, including but not limited to WiFi, Bluetooth, 3G, 4G wireless telecommunication protocols.

In other embodiments, the sending or receiving of data between the performance sensors 3 and the data acquisition module 5 can be through a powerline, or between the data acquisition module 5 and the maintenance server 6 can be through a powerline, or between the maintenance server 6 and the user devices 7 can be through a powerline. Any suitable powerline communication protocol or protocols can be used.

In some embodiments, one or more of the performance sensors 3 are integrated with the lighting device 4. The data acquisition module 5 can also be integrated with the lighting device 4.

Generally, in most applications, the predetermined deficiency threshold represents a minimum acceptable lighting level or range for an application. This is much more precise and direct measure of the operation of lighting devices 4. It does not rely on estimates calculated from the power drawn by the lighting device 4 or the current running through the lighting device 4.

In some applications, however, the predetermined deficiency threshold represents a value for the performance parameter that corresponds to failure of the lighting device 4 in a predetermined timeframe in accordance with a predictive maintenance model of the lighting device 4.

Another advantageous feature is that the maintenance server 6 can record the performance data over time and analyze the performance data to perform predictive maintenance activities. The maintenance server 6 can construct a predictive maintenance model of the lighting device 4 or lighting system 2 based on historic performance data recorded from the lighting device itself or the lighting system itself. For example, the maintenance server 6 can calculate a deterioration rate of the performance parameter and the predetermined deficiency threshold is a predetermined deterioration rate. The maintenance server can also calculate a total usage time and the predetermined deficiency threshold is reached when the total usage time reaches an operating lifetime for the lighting device.

The present invention also provides in another aspect a method of maintaining a lighting system. A broad embodiment of the method comprises: detecting at least one performance parameter of the lighting device 4 in the lighting system 2; sending performance data corresponding to the performance parameter to the maintenance server 6; sending the open maintenance request 8 to the user device 7 when the performance data reaches a predetermined deficiency threshold; receiving a user input at the user device 7 to indicate an acceptance of the open maintenance request 8 and to send the acceptance to the maintenance server 6; changing the open maintenance request 8 to a closed maintenance request 9 at the maintenance server 6; and sending the closed maintenance request 9 to the user device 7.

Usually, the open maintenance request 8 is sent to a plurality of the user devices 7 when the performance data reaches the predetermined deficiency threshold, the open maintenance request 8 is changed to the closed maintenance request 9 at the maintenance server 6 and the closed maintenance request 9 is sent to all the user devices 7 when the user input is received at one of the user devices 7 to indicate the acceptance of the open maintenance request 8 and to send the acceptance to the maintenance server 6.

Other features of other embodiments of the method are easily appreciated from the foregoing detailed description.

It is also appreciated that the aforesaid embodiments are only exemplary embodiments adopted to describe the principles of the present invention, and the present invention is not merely limited thereto. Various variants and modifications can be made by those of ordinary skill in the art without departing from the spirit and essence of the present invention, and these variants and modifications are also covered within the scope of the present invention. Accordingly, although the invention has been described with reference to specific examples, it is appreciated by those skilled in the art that the invention can be embodied in many other forms. It is also appreciated by those skilled in the art that the features of the various examples described can be combined in other combinations.

1. A maintenance system for maintaining a lighting system, the maintenance system comprising:
at least one performance sensor for detecting a performance parameter of a lighting device in the lighting system;
a data acquisition module for receiving performance data from the performance sensor, the performance data corresponding to the performance parameter;
a maintenance server for receiving the performance data from the data acquisition module; and
a user device, the maintenance server sending an open maintenance request to the user device when the performance data reaches a predetermined deficiency threshold, the user device adapted to receive a user input to indicate an acceptance of the open maintenance request and to send the acceptance to the maintenance server, the maintenance server then changing the open maintenance request to a closed maintenance request and sending the closed maintenance request to the user device.

2. A maintenance system according to claim 1 comprising a plurality of the user devices, the maintenance server sending the open maintenance request to all the user devices when the performance data reaches the predetermined deficiency threshold, and the maintenance server changing the open maintenance request to the closed maintenance request and sending the closed maintenance request to all the user devices when one of the user devices receives the user input to indicate the acceptance of the open maintenance request and sends the acceptance to the maintenance server.

2-4. (canceled)

5. A maintenance system according to claim 1 wherein the user device is adapted to receive a user input to indicate a completed maintenance request and to send the completed maintenance request to the maintenance server.

6. A maintenance system according to claim 5 wherein the open maintenance request comprises a request to replace the lighting device, the lighting device being replaced by another lighting device being a smart lighting device having configurable characteristics, and the maintenance server sending configuration data to said another lighting device to configure the characteristics of said another lighting device after receiving the completed maintenance request.

7. A maintenance system according to claim 6 wherein the lighting device is also a said smart lighting device, and the configuration data sent to said another lighting device is the configuration data for the lighting device.

8-10. (canceled)

11. A maintenance system according to claim 1 wherein at least one performance sensor comprises a light detector and the performance parameter is a light level outputted by the lighting device.

12-14. (canceled)

15. A maintenance system according to claim 11 wherein the light detector filters out light frequencies that are not the main light frequencies emitted by the lighting device to minimise detection of ambient light and maximize detection of light provided by the lighting device.

16. A maintenance system according to claim 1 wherein a power supplied to the lighting device is automatically increased to restore the light level outputted by the lighting device to a desired level when the light level reaches a predetermined deterioration threshold.

17. A maintenance system according to claim 1 wherein at least one performance sensor comprises a current detector and the performance parameter is a current flowing through the lighting device.

18. (canceled)

19. A maintenance system according to claim 1 wherein at least one performance sensor comprises a temperature detector and the performance parameter is a temperature of the lighting device.

20-21. (canceled)

22. A maintenance system according to claim 19 wherein a power supplied to the lighting device is automatically decreased to reduce the temperature of the lighting device when the temperature reaches a maximum operating temperature.

23. A maintenance system according to claim 1 wherein the lighting device is an emergency lighting device powered by a battery when mains power to the emergency lighting device or the lighting system is cut, the maintenance server initiating at a predetermined time an automatic test of the emergency lighting device by cutting mains power supplied to the emergency lighting device or the lighting system, the at least one performance sensor detecting the performance parameter of the emergency lighting device during the automatic test.

24-27. (canceled)

28. A maintenance system according to claim 1 wherein the lighting system is an existing lighting system, and the at least one performance sensor and the data acquisition module are retrofitted to the lighting system.

29-33. (canceled)

34. A maintenance system according to claim 1 wherein the predetermined deficiency threshold represents a minimum acceptable lighting level or range for an application.

35. A maintenance system according to claim 1 wherein the predetermined deficiency threshold represents a value for the performance parameter that corresponds to failure of the lighting device in a predetermined timeframe in accordance with a predictive maintenance model of the lighting device.

36. A maintenance system for maintaining a lighting system, the maintenance system comprising:
at least one performance sensor for detecting a performance parameter of an emergency lighting device in the lighting system, the emergency lighting device powered by a battery when mains power to the emergency lighting device or the lighting system is cut;
a data acquisition module for receiving performance data from the performance sensor, the performance data corresponding to the performance parameter; and
a maintenance server for receiving the performance data from the data acquisition module, and initiating at a predetermined time an automatic test of the emergency lighting device by cutting mains power supplied to the emergency lighting device or the lighting system, the at least one performance sensor detecting the performance parameter of the emergency lighting device during the automatic test.

37-38. (canceled)

39. A maintenance system according to claim 1 wherein the maintenance server records the performance data over time and analyses the performance data to perform predictive maintenance activities.

40. A maintenance system according to claim 39 wherein the maintenance server calculates a deterioration rate of the performance parameter and the predetermined deficiency threshold is a predetermined deterioration rate.

41. (canceled)

42. A method of maintaining a lighting system, the method comprising:
detecting at least one performance parameter of a lighting device in the lighting system;
sending performance data corresponding to the performance parameter to a maintenance server;
sending an open maintenance request to a user device when the performance data reaches a predetermined deficiency threshold;
receiving a user input at the user device to indicate an acceptance of the open maintenance request and to send the acceptance to the maintenance server;
changing the open maintenance request to a closed maintenance request at the maintenance server; and
sending the closed maintenance request to the user device.

43. A method according to claim 42 wherein the open maintenance request is sent to a plurality of the user devices when the performance data reaches the predetermined deficiency threshold, the open maintenance request is changed to the closed maintenance request at the maintenance server and the closed maintenance request is sent to all the user devices when the user input is received at one of the user devices to indicate the acceptance of the open maintenance request and to send the acceptance to the maintenance server.
